(19) United States
(12) Patent Application Publication
(10) Pub. No.: US 2009/0311993 A1
(43) Pub. Date: Dec. 17, 2009

(54) METHOD FOR INDICATING AN ACTIVE VOICE CALL USING ANIMATION

(76) Inventor: Samuel Jacob HORODEZKY, San Diego, CA (US)

Correspondence Address: QUALCOMM INCORPORATED, 5775 MOREHOUSE DR., SAN DIEGO, CA, 92121, US

(21) Appl. No.: 12/139,706

(22) Filed: Jun. 16, 2008

(51) Int. Cl. H04M 1/663

(52) U.S. Cl. 455/412.2

(57) ABSTRACT

Systems and methods for indicating to a user in a glance whether a voice call session is active or not. The systems and methods utilizing graphical images shown on a user interface output display which exhibit motion to indicate that a voice call session is active. The systems and methods further use a static version of the graphical images shown on a user interface output display to indicate that a voice call session has ceased. The systems and methods further utilizing the graphical image shown on the user interface output display to indicate the duration of a ceased voice call session.

### FIELD OF THE INVENTION

The present invention relates generally to cellular telephone displays, and more particularly to displays to indicate that a voice call is ongoing.

### BACKGROUND

Usage of wireless mobile communication devices (mobile devices), such as cellular telephones, is ever increasing due to their portability and connectivity. Mobile devices are also growing in sophistication, supporting many useful applications that can run simultaneously, becoming multipurpose productivity tools. With so much capability and usefulness, users can lose track of the applications that are running, and even whether a call is active, such as a call that was placed on hold or accidentally placed. Thus, there is a need for improved user interfaces and displays that efficiently communicate the status of mobile devices.

### SUMMARY

Various embodiment systems and methods are disclosed which utilize animation to indicate an active voice call session on a mobile device. During an active call, an animation which features continuous and obvious motion is displayed to indicate an active call. In some embodiments, when the call ends, the animation may stop moving to indicate the call has ceased. In some embodiments, when the call ends, the animation simply is replaced by the normal or idle display. Indicating the call status with animation allows the user to directly and immediately perceive the status of a voice call session. Various embodiments disclosed herein provide themeable animations to indicate both that a call is in session and the duration of the session. When the voice call session is over the animation indicates through the lack of motion that the voice call session has been terminated. The static image may also show the duration of the call.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1a is an example of an animation display for use with an embodiment.

FIG. 1b is a second example of an animation display for use with an embodiment.

FIG. 1c is a third example of an animation display for use with an embodiment.

FIGS. 2a-2c are examples of a series of images which are shown in succession to exhibit motion in an embodiment.

FIG. 3 is a process flow diagram of an embodiment.

FIG. 4 is a process flow diagram of an alternative embodiment.

FIG. 5 is a process flow diagram of another alternative embodiment.

FIG. 6 is a system block diagram of a mobile device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “mobile device”, “mobile handset”, “handset” and “handheld device” refer to any one or all of cellular telephones, personal digital assistants (PDAs) with wireless modems, wireless electronic mail receivers (e.g., the Blackberry® and Treo® devices), multimedia Internet enabled cellular telephones (e.g., the iPhone®), wireless telephone receivers and similar personal electronic devices. In a preferred embodiment, the mobile device is a cellular handset device (e.g., a cellphone). However, cellular telephone communication capability is not necessary as the various embodiments may initiate a voice call session using Voice over Internet Protocol (VoIP) via a wired or wireless (e.g., WiFi) communications network. Conventional telephones which include a processor, and desktop and laptop computers may also implement the various embodiment methods disclosed herein.

Technological developments have greatly expanded the means by which people speak with one another. Wireless communication devices, such as cellular telephones, are increasingly replacing conventional land line telephones. In addition, computer applications such as Skype™ allows users to call virtually any wireless or conventional telephone via their computers.

For a variety of reasons users frequently refer to the display of their mobile device to determine if a call is in session. While users may own the communication equipment terminal (e.g., mobile device, computer, laptop, etc.) they still must pay service providers for access to the communication network resources. Typically, users are charged for the time, in small increments that are quantized, that they access a service provider's network resources. In most instances, service providers charge users for the full minute of access as soon as the minute begins. In response, users may monitor the call durations closely to minimize their charges. Cellular communications are notoriously susceptible to interruptions which occur without warning and without any tonal indication that the call is no longer in session. In such cases, users must look at their mobile device display to determine if the call is still in session. Also, many cellular service providers enable users to place one call on hold while making or receiving another call. Callers “on hold” may receive no tonal indication of whether their call is still active, and must look to the mobile device display to decide if they should continue to hold or have been cut off by the other party. As another example, mobile device user may be unable to distinguish a connected call on mute from a terminated or dropped call without looking at the display. Given the small size of mobile devices and the way in which they are typically used (e.g., while driving), it is desirable to provide users with an intuitive display that shows them at a glance whether a voice call session is active and the duration of the voice call.

Conventional mobile device user interfaces display a digital timer to indicate the current duration of a call. Such user interfaces increment the time value in units of one second or more. Some mobile devices flash the duration counter when the call ends, but many simply stop incrementing. The disadvantages of such conventional displays are twofold. First, the user must wait up to one second to perceive the state of the mobile device by noting whether the timer is incrementing. In other words, it takes time for the user to discern whether a voice call session is active or not. Second, those conventional user interfaces that flash to show a call is ended are counter-intuitive in that they use motion to indicate the voice call session. In other words, only when the call has ended does the user interface output display any form of motion.

Embodiments disclosed herein utilize animated graphical images or icons that convey constant motion to indicate that a voice call is active and ongoing. The animated images or icons halts the motion to indicate that the voice call has been terminated. In this manner, a user can determine instantaneously whether a voice call is active or not simply by glancing at the user interface output display. If the graphic shown on the user interface output display is moving, then the user knows that a voice call is active. If the graphic shown on the user interface is not moving, then the user will know that a voice call has been terminated. By using active and continuous animation, versus periodic incrementing, the active and continuous motion of the image or icon will be instantly recognized by users. Such animations may be part of the user's themes or selected by the user from a variety of alternative animations.

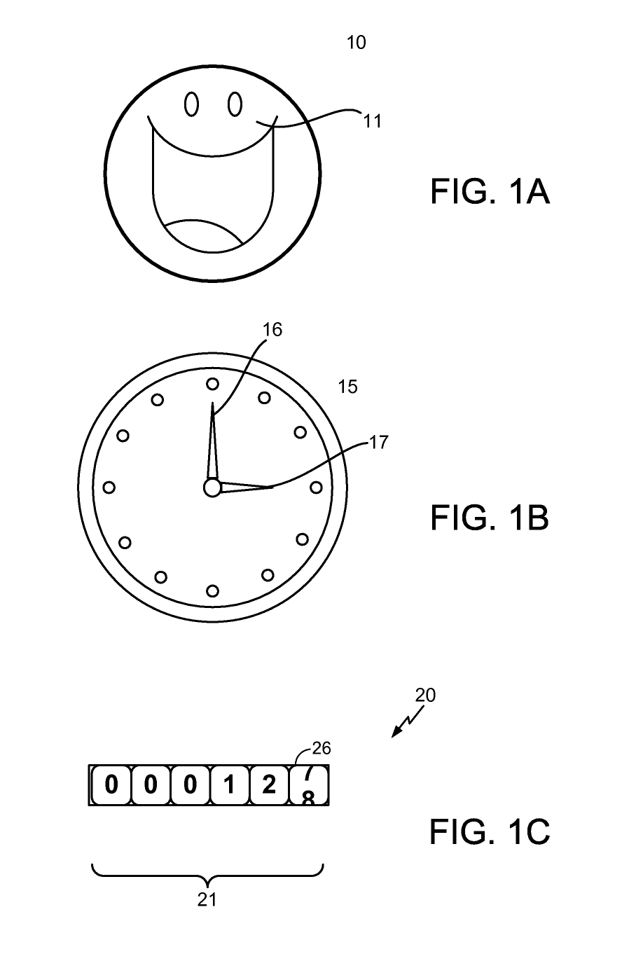

Examples of graphical images or icons which can be displayed are shown in FIGS. 1a-1c. FIG. 1a illustrates a graphical emoticon 10 (sometimes referred to as a smiley face) which may be shown on a user interface output display. As soon as a voice call is activated, the graphic may begin its animation sequence by having the mouth 11 of the emoticon 10 begin to move as if it were talking. Animation of a smiley face emoticon 10 is easily accomplished in software by providing two to three images (e.g., one with a mouth open expression, one with a mouth closed expression, and one with an intermediate expression) that are displayed sequentially in a loop that increments images every tenth of a second or so. The emoticon 10 may further include some indication of sound waves emanating from the mouth, such as musical notes or a moving sequence of arched lines. The mouth of the emoticon 10 continually moves so long as the voice call is active. This continuous movement of the mouth indicates to a user that a voice call is active. When the voice call is terminated, the mouth may stop moving and assume a mouth closed expression, for example, to indicate to the user that the voice call has terminated. Alternatively, the emoticon 10 may be removed from the display when the call terminates, indicating to the user in a glance by its absence that the voice call has terminated.

FIG. 1b illustrates an alternative embodiment in which the graphical element shown on the user interface output display is a stopwatch 15. When a voice call is activated the graphic may begin an animation sequence in which the minute hand 16 and/or second hand 17 sweep across the face of the stop watch. The stopwatch 15 may further include a hand (not shown) which measures tenths, or hundredths of elapsed seconds, and thus sweep very quickly. The hands 16, 17 of the stopwatch 15 continually sweep across the face so long as the voice call is active. This continuous sweeping motion indicates to a user at a glance that a voice call is active. When the voice call is terminated, the minute and second hands may stop moving, thus indicating to the user that the voice call has terminated. The position of the hands when stopped may also indicate the elapsed time of the just ended call session. Alternatively, the stopwatch 15 may be removed from the display when the call terminates, indicating to the user in a glance by its absence that the voice call has terminated.

FIG. 1c illustrates another alternative embodiment in which an odometer 20 is shown on a user interface output display. When a voice call is activated the graphic may begin an animation sequence in which the wheels 21 of the odometer 20 begin to roll. For example, the right most wheel 26 of the odometer represents elapsed seconds or tenths of a second. As time elapses during an active voice call, the wheels 21 of the odometer 20 continue to smoothly rollover (versus increment as in conventional displays) so long as the voice call is active. This continuous rolling motion indicates to a user at a glance that a voice call is active. When the voice call is terminated, the odometer wheels 21 may stop moving, thus indicating to the user that the voice call has terminated. Alternatively, the odometer 20 may be removed from the display when the call terminates, indicating to the user in a glance by its absence that the voice call has terminated.

Embodiments may be implemented in which the graphic animation shown on the user interface output display can be chosen from variety of different moving images. Still other embodiments may be implemented in which the graphic animation shown on the user interface output display is coordinated with a theme of the user's choosing. For example, race cars may be shown to race around a track while a voice call session is active. The race cars may halt when the voice call session ceases. Other example animations include a runner running or a swimmer swimming while a voice call session is active. As with the other embodiments, the animation ceases motion as soon as the voice call session is terminated. Any graphical image that can be incorporated into an animation sequence may be utilized.

A number of different animation images or icons may be provided with a menu application provided to enable a user to select a particular animated image or icon to indicate call status. A limited number of animation images or icons may be loaded into the memory of the mobile device or computer by an original equipment manufacturer. Additionally or alternatively, the user may select animation images or icons from a menu to be downloaded into the mobile device or computer. Still further, users may generate or design an image or icon of their own choosing for use in the embodiment methods. In each case, the image may be loaded into the memory of the mobile device or computer which executes the call active animation routine. Animation images or icons may be selected for or based upon a theme applied to or selected for the mobile device or computer.

A variety of approaches may be taken to animate images or icons shown on the user interface output display. In a first approach, users may elect to execute a theme or skin on their mobile device or computer that includes a voice active animation that is consistent with the theme or skin. In an embodiment, themes which include wallpapers, ring tones, customized skins and buttons can be selected as a package and downloaded into the user's device. Included in the various downloaded files which contain the various theme elements may be a call active animation file which contains a number of images coordinated to the elected theme or skin which, when shown in succession (e.g., in a flicker loop), exhibits motion.

In a second approach, a call active animation routine theme may be downloaded into a user's device memory as a separate file. Call active animation routines may be offered for download with a variety of shapes, colors and animations so that users may select an animation that matches the user's theme or skin. This approach allows users to coordinate their call active animation routine with the rest of the user's theme already running on the user's device.

In a third approach, an application may be provided on the mobile device or on another computer to enable users to select a portion of the user's theme (or another image) to be animated. Such an application may be a simple select-and-copy image selection tool configured to enable the user to create an image for animation by copying it from a portion of the theme or another image. Thus, the copied image may be part of the implemented theme or may be a portion of another image such as a photograph or JPEG file that the user has elected to display on the mobile device. The copied image is then modified incrementally to create a series of slightly modified images such that when the modified images are sequentially displayed, a user perceives a moving image. The modified images may be generated in advance and stored in memory as a sequence of images for display (e.g., in a cine loop), or the portions may be sequentially modified and displayed in a loop to create the animation.

In other embodiments, in addition to indicating to the user when a voice call session is active, the graphical elements may indicate the total duration of the voice call to the user. For example, if the graphical animation image is a stopwatch 15 or odometer 20 as shown in FIGS. 1b and 1c, respectively, the motion or lack thereof may quickly inform the user whether the voice call session is active or not. Then, once the animation sequence halts its motion, the resulting graphical image informs the user of the duration of the preceding voice call session. For example, if the stopwatch 15 image of FIG. 1b is used, when the hands 16, 17 stop moving (indicating termination of a voice call session) the static image informs the user of elapsed time of the preceding voice call session. Similarly, the static image of the odometer 20 shows the elapsed time of the preceding voice call session. In this manner, the user is able to quickly determine that the duration of the preceding voice call session lasted.

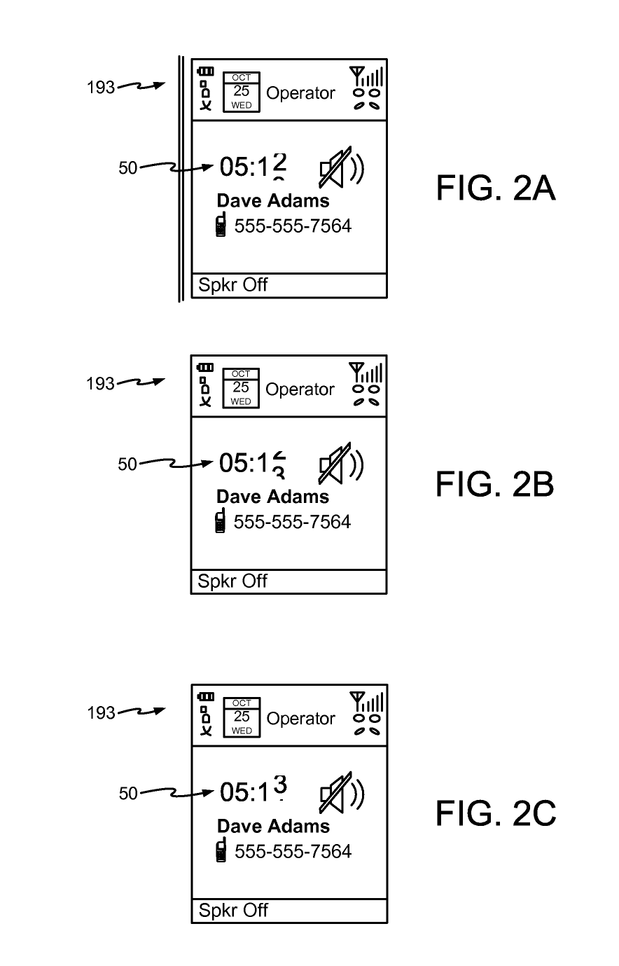

FIGS. 2a-2b are screen shots of an illustrative user interface output display which displays a series of images in succession (e.g., in a cine loop) which exhibits motion while a voice call is active. In the example shown in FIGS. 2a-2d an odometer type timer 50 is shown on the user interface output display 193. FIG. 2a shows the odometer type timer 50 displaying that 5 minutes and 12 seconds have elapsed thus far during a voice call to “Dave Adams.” FIG. 2a shows the last wheel of the odometer style timer 50 rolling over to the next second. FIG. 2b shows the last wheel of the odometer style timer progressing so the digit 2 is becoming less visible while the digit 3 is becoming more visible. When displayed in succession, the screen shots of FIGS. 2a and 2b given the impression to the user that the odometer style timer is in constant motion. FIG. 2c shows digit “2” almost completely rolled up, while the digit “3” is nearly entirely visible. When the voice call is terminated, a static image of the odometer type timer 50 may be momentarily displayed so that the user is informed of the total time elapsed during the voice call session. For example, if the voice call terminated at the time shown in FIG. 2c, the user would know that the voice call took just under 5 minutes and 12 seconds.

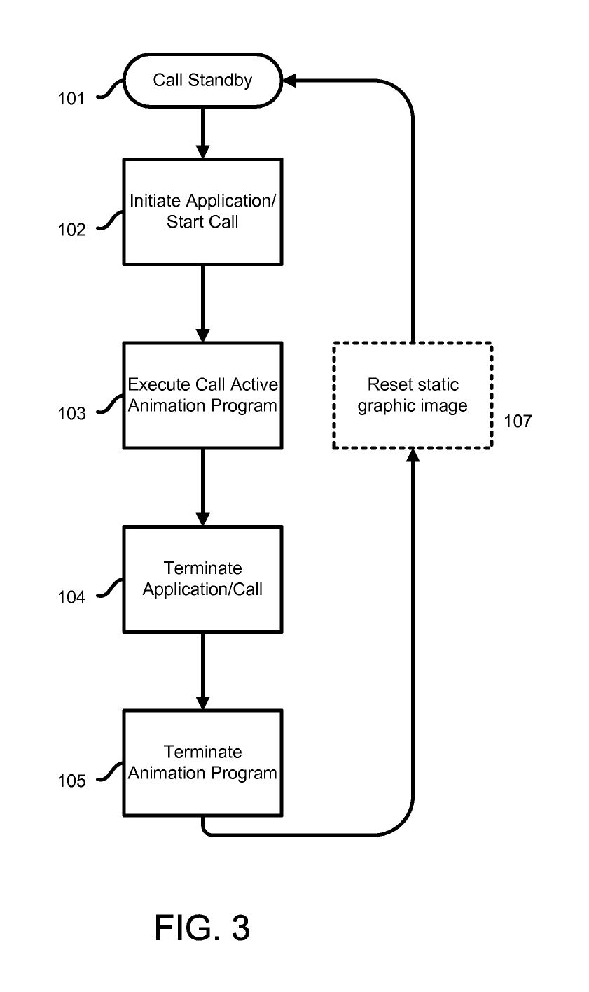

An animated voice call active indicator may be implemented in software instructions operating on the mobile device employing a variety of software methods. FIG. 3 illustrates a process flow diagram of an example embodiment. In this example, the mobile device or computer (laptop or desktop) is initially in a “call standby” state, 101. When in the “call standby” state 101, the processor of the mobile device or computer may manage communication links and cell-to-cell handovers, monitor incoming communications for a new call, and monitor the user interface to determine if a user is initiating a call using a dialing sequence or “send” key, all of which are well known in the cellular telephone arts. While in the call standby state 101, the processor of the mobile device or computer may show a static image in the user interface output display. This static image will subsequently become animated and exhibit motion once a voice call session is initiated. The static graphic image may form part of the user's theme as it may be an integral part of the user's displayed wallpaper. Alternatively, no static image may be displayed until a voice call session is initiated, at which point the image appears and exhibits motion.

A user may initiate a voice call by dialing a number or by answering an incoming call, step 102. Once the user initiates a voice call, an animation program is executed that presents a graphic exhibiting motion, step 103. In embodiments where a static image is previously displayed, execution of the animation program, step 103, causes the static image to exhibit motion. In embodiments where no static image is previously displayed, execution of the animation program, step 103, generates or recalls from memory graphical images which are displayed in sequence to exhibit motion. So long as the graphic shown on the user interface output display continues to exhibit motion, the user is notified that the voice call session is active.

The animation program may implement a variety of known methods for presenting moving graphics on the display of a mobile device. In a simple example, the animation program may simply sequence through a series of incrementing images (e.g., a cine loop) stored in memory that are shown sufficiently rapidly to appear as continuous movement.

The animation program continues to execute the animation sequence until the call is terminated, step 104, such as by the user hanging up, the other side hanging up, or the call being terminated by the communication network (e.g., a “dropped call”). When the voice call terminates, the animation program is deactivated, step 105. In an embodiment termination of the animation program leaves the graphic shown on the user interface output display but without any motion (i.e., as a static image). In another embodiment, termination of the animation program removes the graphic from the display, such as returning to the normal stand-by display. In embodiments in which the static graphical image shown in the user interface output display shows the duration of the voice call session, this static image may remain on the display until reset by the user, optional step 107. In step 107, the user may reset the static graphical image shown on the user interface output display to a base state by pressing a button. Alternatively, or in addition, the static graphical image may reset to a base state display after a preset passage of time. For example, the base state may be a display with no call indicator at all, an odometer which displays all zeros or a stopwatch in which the hands are returned to the 12 o'clock position. Once the animation program is terminated, step 105, the process returns to the call standby state, step 101, until a new voice call is initiated.

As mentioned above, in an embodiment the animated graphic may be shown in a static position on the user interface output display anytime the processor is in a call standby state, 101. For example, as part of a selected mobile device theme a user may choose to display his favorite NASCAR® driver's car as a wallpaper that is shown whenever the processor of the mobile device or computer is in a call standby state. Once a voice call session is activated, the NASCAR® driver's car may start to drive across the user interface output display or the wheels may turn until the voice call session is terminated.

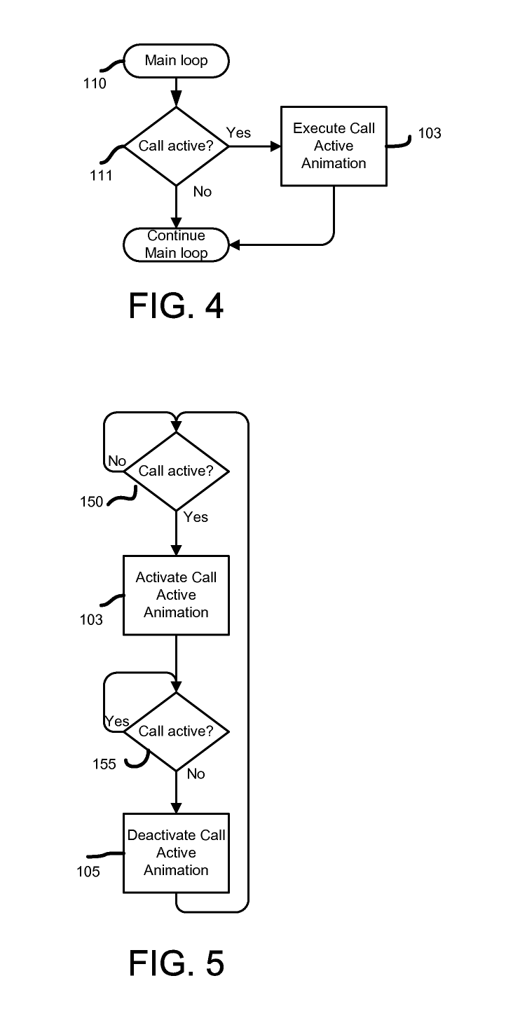

FIG. 4 illustrates a process flow of an alternative embodiment for generating an animated call status indication. This embodiment may be implemented as part of the mobile device or computer processor main loop routine 110. A main loop routine 110 may be used to control the various applications and functions of the mobile device or computer. When a user initiates a voice call session, a call active flag may be set (such as by storing a “1” in a particular memory register) indicating that a voice call session is active. When the user terminates the voice call session, the call active flag is reset (such as by storing a “0” in the particular memory register). The main loop routine 110 may periodically monitor the call active flag, step 111. The periodicity may be set to check the call active flag at an interval faster than 1 Hz. If the call active flag is set (i.e., Test 111=“Yes”), indicating an active voice call session is in process, the processor may execute a call active animation routine, step 103, in a manner similar to that described above with reference to FIG. 3. The call active animation routine 103 may be configured to exhibit motion of a graphical image shown on the user interface output display until the next periodic check of the call active flag. Once the call active animation routine 103 is executed, the processor returns to the main loop routine, step 112. If the user has terminated his voice call session in the interim of the last call active flag check, step 111, the call active flag will be reset (i.e., Test 111=“No”) and the processor will not execute the call active animation routine 103, instead proceeding with the main loop routine, step 112. In this manner, every few milliseconds the mobile device or computer processor tests the call active flag and sets the animation display in response.

In a variation of this embodiment, a step may be included which sets a “call active display on” flag when the call active animation program is first executed by the mobile device or computer processor. By setting this flag, the processor is aware that the animation program is executing. In this alternative embodiment, the graphical image may need to be reset to its original base setting when the call active is reset (i.e., Test 111=“No”). Consequently, if the “call active display on” is set but the call active flag is reset (indicating the call has been terminated), an additional step (not shown) may be implemented which terminates the call active animation program.

FIG. 5 illustrates a process flow of an alternative embodiment for generating an animated call status indication. In this embodiment, the processor of the mobile device or computer continually monitors the voice call session status, such as by monitoring a call active status flag such as described above with reference to FIG. 4. If there is no active voice call (i.e., Test 150=“No”), the processor continues to periodically monitor the call session status (e.g., by checking a call active status flag every few milliseconds). A slight delay may optionally be included in the monitoring loop to minimize processor overhead. If a voice call session is active (i.e., Test 150=“Yes”), the processor may activate the call active animation routine, step 103, in a manner similar to that described above. By activating the call active animation routine 103, the user interface output display will show a graphical image exhibiting motion to indicate that the voice call session is active. Once the call active animation routine has been executed, the processor may continue to monitor the voice call session status in order to determine when the voice call session ends, step 155. If the voice call session remains active (i.e., Test 155=“Yes”), the processor will continue to monitor the voice call session status, step 155. Once the voice call session terminates (i.e., Test 155=“No”), the processor deactivates the call active animation routine, step 105. Once the call active animation routine has been deactivated, step 105, the processor returns to monitoring the call active status for initiation of the next voice call session.

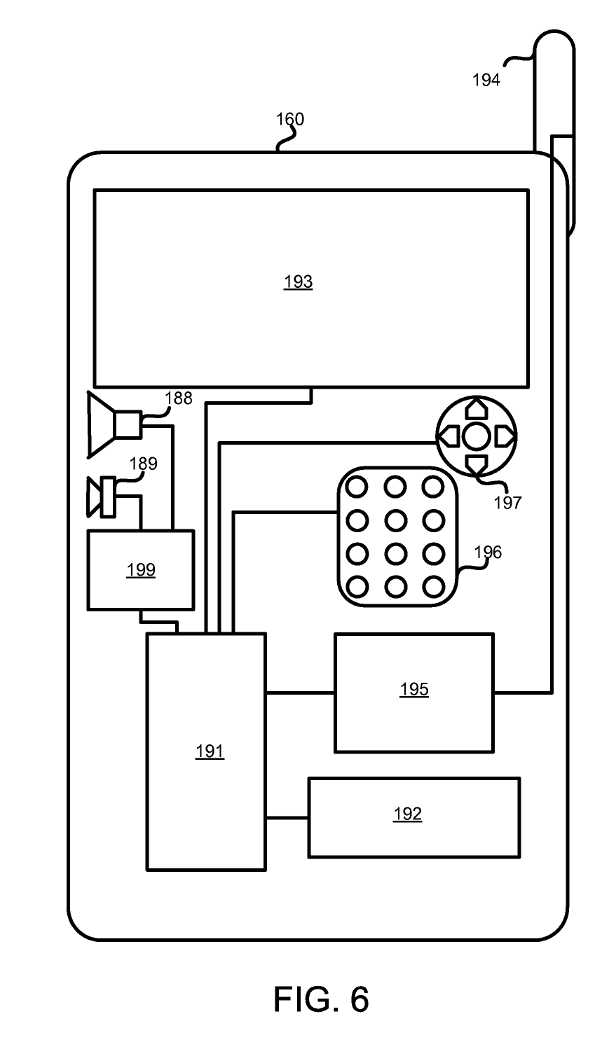

The embodiments described above may be implemented on any of a variety of mobile devices, such as, for example, cellular telephones, personal data assistants (PDA) with cellular telephone, mobile electronic mail receivers, mobile web access devices, and other processor equipped devices that may be developed in the future that connect to a wireless network. In addition, the embodiments described above may be implemented on any of a variety of computing devices, including but not limited to desktop and laptop computers. FIG. 6 depicts various components of a mobile device 160 capable of supporting the various embodiments disclosed herein. Although the components of a mobile device 160 are illustrated, one of skill in the art would appreciate that the same components may also be implemented in a computer (portable or otherwise) to further support the implementation of the various embodiments disclosed herein. The depiction of the mobile device 160 as a cellular telephone is merely for illustrative purposes. Also, the embodiments described above may be implemented on any telephone device which includes the components illustrated in FIG. 6.

A typical mobile handset 160 includes a processor 191 coupled to internal memory 192 and a user interface output display 193. Additionally, the mobile handset 160 may have an antenna 194 for sending and receiving electromagnetic radiation that is connected to a wireless data link and/or cellular telephone transceiver 195 coupled to the processor 191. In some implementations, the transceiver 195, and portions of the processor 191 and memory 192 used for cellular telephone communications is referred to as the air interface since it provides a data interface via a wireless data link. Further, the mobile device 160 includes a speaker 188 to produce audible audio signals to the user. The mobile device also includes a microphone 189 for receiving the audio speech of the user. Both microphone 189 and speaker 188 may be connected to the processor 191 via a vocoder 199 which transforms the electrical signals into sound waves and vice versa. In some implementations, the vocoder 199 may be included as part of the circuitry and programming of the processor 193.

The processor 191 may be any programmable microprocessor, microcomputer or multiple processor chip or chips that can be configured by software instructions (applications) to perform a variety of functions, including the functions of the various embodiments described above. In some mobile devices, multiple processors 191 may be provided, such as one processor dedicated to wireless communication functions and one processor dedicated to running other applications. Typically, software applications may be stored in the internal memory 192 before they are accessed and loaded into the processor 191. In some mobile devices, the processor 191 may include internal memory sufficient to store the application software instructions. For the purposes of this description, the term memory refers to all memory accessible by the processor 191, including internal memory 192 and memory within the processor 191 itself. The memory 192 may be volatile or nonvolatile memory, such as flash memory, or a mixture of both. Mobile handsets typically include a key pad 196 or miniature keyboard and menu selection buttons or rocker switches 197 for receiving user inputs.

The various embodiments described above may be implemented on a typical mobile device 160 by initiating a voice call session via input keypad device 196 and/or menu selection buttons 197 and an application dispatcher in memory 192 which comprises processor executable software instructions that will cause the processor 191 to execute the embodiment methods described herein to display an animated graphical image on user interface output display 193.

The hardware used to implement the foregoing embodiments may be processing elements and memory elements configured to execute a set of instructions, wherein the set of instructions are for performing method steps corresponding to the above methods. Alternatively, some steps or methods may be performed by circuitry that is specific to a given function.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. The software module may reside in a processor readable storage medium and/or processor readable memory both of which may be any of RAM memory, flash memory, ROM memory, EPROM memory, EEPROM memory, registers, hard disk, a removable disk, a CD-ROM, or any other tangible form of data storage medium known in the art. Moreover, the processor readable memory may comprise more than one memory chip, memory internal to the processor chip, in separate memory chips, and combinations of different types of memory such as flash memory and RAM memory. References herein to the memory of a mobile handset are intended to encompass any one or all memory modules within the mobile handset without limitation to a particular configuration, type or packaging. An exemplary storage medium is coupled to a processor in either the mobile handset or the theme server such that the processor can read information from, and write information to, the storage medium. In the alternative, the storage medium may be integral to the processor. The processor and the storage medium may reside in an ASIC.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

We claim:

1. A method for indicating a voice call session status, comprising:
activating a call active animation routine upon initiation of a voice call session; and
deactivating the call active animation routine upon termination of the voice call session.

2. The method of claim 1, wherein said step of activating the call active animation comprises displaying a sequence of images to exhibit continuous motion on a user interface output display.

3. The method of claim 2, wherein said step of deactivating the call animation routine comprises displaying a static image on the user interface output display.

4. The method of claim 2, wherein said step of activating the call active animation further comprises recalling the sequence of images from memory.

5. The method of claim 2, wherein said step of activating the call active animation comprises modifying a recalled image to generate a plurality of modified images such that motion is perceived when the plurality of modified images are exhibited on the user interface output display in succession.

6. The method of claim 4, wherein the recalled sequence of images are coordinated with a theme selected by a user.

7. The method of claim 5, wherein the recalled image is a portion of a theme selected by the user.

8. The method of claim 2, wherein said step of activating the call active animation comprises sequentially modifying a portion of a theme implemented on the user interface output display and displaying the modified portion on the user interface output display such that motion is perceived on the portion of the user interface output display in succession.

9. The method of claim 3, further comprising removing the static image from the user interface output display after a pre-determined period of time has elapsed.

10. The method of claim 3, further wherein the static image on the user interface output display indicates the duration of the terminated voice call session.

11. The method of claim 10, further comprising resetting the static image to a base setting after a pre-determined period of time has elapsed.

12. A method for indicating a voice call session status, comprising:
monitoring the voice call session status;
activating a call active animation routine if a voice call session is active; and
deactivating the call active animation routine if the voice call session is no longer active.

13. The method of claim 12, wherein said step of activating the call active animation comprises displaying a sequence of images which exhibits motion on a user interface output display.

14. The method of claim 13, wherein said step of deactivating the call active animation routine comprises displaying a static image on the user interface output display.

15. The method of claim 13, wherein said step of activating the call active animation further comprises recalling the sequence of images from memory.

16. The method of claim 13, wherein said step of activating the call active animation comprises modifying a recalled image to generate a plurality of modified images such that motion is perceived when the plurality of modified images are exhibited on the user interface output display in succession.

17. The method of claim 15, wherein the recalled sequence of images are coordinated with a theme selected by a user.

18. The method of claim 15, wherein the recalled image is a portion of a theme selected by the user.

19. The method of claim 13, wherein said step of activating the call active animation comprises sequentially modifying a portion of a theme implemented on the user interface output display and displaying the modified portion on the user interface output display such that motion is perceived on the portion of the user interface output display in succession.

20. The method of claim 14, further comprising removing the static image from the user interface output display after a pre-determined period of time has elapsed.

21. The method of claim 14, further wherein the static image on the user interface output display indicates the duration of the terminated voice call session.

22. The method of claim 21, further comprising resetting the static image to a base setting after a pre-determined period of time has elapsed.

23. A mobile device, comprising:
a user interface output display;
an input keypad device;
a processor coupled to the input keypad device and the user interface output display;
a memory coupled to the processor; said memory having stored therein processor-executable software instructions configured to cause the processor to perform steps comprising:
activating a call active animation routine upon initiation of a voice call session; and
deactivating the call active animation routine upon termination of the voice call session.

24. The mobile device of claim 23, wherein the processor-executable software instructions stored in the memory are configured to cause the processor to further perform steps comprising displaying a sequence of images which exhibits continuous motion on the user interface output display.

25. The mobile device of claim 24, wherein the processor-executable software instructions stored in the memory are configured to cause the processor to further perform steps comprising displaying a static image on the user interface output display.

26. The mobile device of claim 24, wherein the processor-executable software instructions stored in the memory are configured to cause the processor to further perform steps comprising recalling the sequence of images from the memory.

27. The mobile device of claim 24, wherein the processor-executable software instructions stored in the memory are configured to cause the processor to further perform steps comprising modifying a recalled image to generate a plurality of modified images such that motion is perceived when the plurality of modified images are exhibited on the user interface output display in succession when the call activation step is activated.

28. The mobile device of claim 26, wherein the recalled sequence of images are coordinated with a theme selected by a user.

29. The mobile device of claim 26, wherein the recalled image is a portion of a theme selected by the user.

30. The mobile device of claim 24, wherein the processor-executable software instructions stored in the memory are configured to cause the processor to further perform steps comprising sequentially modifying a portion of a theme implemented on the user interface output display and displaying the modified portion on the user interface output display such that motion is perceived on the portion of the user interface output display in succession.

31. The mobile device of claim 25, wherein the processor-executable software instructions stored in the memory are configured to cause the processor to further perform steps comprising removing the static image from the user interface output display after a pre-determined period of time has elapsed.

32. The mobile device of claim 25, wherein the static image on the user interface output display indicates the duration of the terminated voice call session.

33. The mobile device of claim 32, wherein the processor-executable software instructions stored in the memory are configured to cause the processor to further perform steps comprising resetting the static image to a base setting after a pre-determined period of time has elapsed.

34. A mobile device, comprising:
a user interface output display;
an input keypad device;
a processor coupled to said input keypad device and user interface output display;
a memory coupled to the processor; said memory having stored therein processor-executable software instructions configured to cause the processor to perform steps comprising:
monitoring a voice call session status;
activating a call active animation routine if the voice call session status is active; and
deactivating the call active animation routine if the voice call session status is no longer active.

35. The mobile device of claim 34, wherein the processor-executable software instructions stored in the memory are configured to cause the processor to further perform steps comprising displaying a sequence of images which exhibits continuous motion on the user interface output display.

36. The mobile device of claim 35, wherein the processor-executable software instructions stored in the memory are configured to cause the processor to further perform steps comprising displaying a static image on the user interface output display.

37. The mobile device of claim 35, wherein the processor-executable software instructions stored in the memory are configured to cause the processor to further perform steps comprising recalling the sequence of images from the memory.

38. The mobile device of claim 34, wherein the processor-executable software instructions stored in the memory are configured to cause the processor to further perform steps comprising modifying a recalled image to generate a plurality of modified images such that motion is perceived when the plurality of modified images are exhibited on the user interface output display in succession when the call activation step is activated.

39. The mobile device of claim 37, wherein the recalled sequence of images are coordinated with a theme selected by a user.

40. The mobile device of claim 37, wherein the recalled image is a portion of a theme selected by the user.

41. The mobile device of claim 34, wherein the processor-executable software instructions stored in the memory are configured to cause the processor to further perform steps comprising sequentially modifying a portion of a theme implemented on the user interface output display and displaying the modified portion on the user interface output display such that motion is perceived on the portion of the user interface output display in succession.

42. The mobile device of claim 34, wherein the processor-executable software instructions stored in the memory are configured to cause the processor to further perform steps comprising removing the static image from the user interface output display after a pre-determined period of time has elapsed.

43. The mobile device of claim 34, wherein the static image on the user interface output display indicates the duration of the terminated voice call session.

44. The mobile device of claim 43, wherein the processor-executable software instructions stored in the memory are configured to cause the processor to further perform steps comprising resetting the static image to a base setting after a pre-determined period of time has elapsed.

45. A mobile device, comprising:
means for activating a call active animation routine upon initiation of a voice call session; and
means for deactivating the call active animation routine upon termination of the voice call session.

46. The mobile device of claim 45, wherein said means for activating the call active animation comprises means for displaying a sequence of images which exhibits continuous motion on a user interface output display.

47. The mobile device of claim 46, wherein said means for deactivating the call animation routine comprises means for displaying a static image on the user interface output display.

48. The mobile device of claim 46, wherein said means for activating the call active animation further comprises means for recalling the sequence of images from a memory.

49. The mobile device of claim 46, wherein said means for activating the call active animation further comprises means for modifying a recalled image to generate a plurality of modified images such that motion is perceived when the plurality of modified images are exhibited on the user interface output display in succession.

50. The method of claim 48, wherein the means for recalling the sequence of images coordinates the sequence of images with a theme selected by a user.

51. The method of claim 48, wherein the means for recalling the sequence of images recalls a portion of a theme selected by the user.

52. The method of claim 46, wherein said means for activating the call active animation further comprises means for sequentially modifying a portion of a theme implemented on the user interface output display and means for displaying the modified portion on the user interface output display such that motion is perceived on the portion of the user interface output display in succession.

53. The mobile device of claim 47, further comprising means for removing the static image from the user interface output display after a pre-determined period of time has elapsed.

54. The mobile device of claim 47, further comprises means for indicating the duration of the terminated voice call session.

55. The mobile device of claim 54, further comprising means for resetting the static image to a base setting after a pre-determined period of time has elapsed.

56. A mobile device, comprising:
means for monitoring a voice call session status;
means for activating a call active animation routine if the voice call session status is active; and
means for deactivating the call active animation routine if the voice call session status is no longer active.

57. The mobile device of claim 56, wherein said means for activating the call active animation comprises means for displaying a sequence of images which exhibits continuous motion on a user interface output display.

58. The mobile device of claim 57, wherein said means for deactivating the call active animation routine comprises means for displaying a static image on the user interface output display.

59. The mobile device of claim 57, wherein said means for activating the call active animation further comprises means for recalling the sequence of images from a memory.

60. The mobile device of claim 57, wherein said means for activating the call active animation further comprises means for modifying a recalled image to generate a plurality of modified images such that motion is perceived when the plurality of modified images are exhibited on the user interface output display in succession.

61. The method of claim 59, wherein the means for recalling the sequence of images coordinates the sequence of images with a theme selected by a user.

62. The method of claim 59, wherein the means for recalling the sequence of images recalls a portion of a theme selected by the user.

63. The method of claim 57, wherein said means for activating the call active animation further comprises means for sequentially modifying a portion of a theme implemented on the user interface output display and means for displaying the modified portion on the user interface output display such that motion is perceived on the portion of the user interface output display in succession.

64. The mobile device of claim 58, further comprising means for removing the static image from the user interface output display after a pre-determined period of time has elapsed.

65. The mobile device of claim 59, further wherein the static image on the user interface output display indicates the duration of the terminated voice call session.

66. The mobile device of claim 65, further comprising means for resetting the static image to a base setting after a pre-determined period of time has elapsed.

67. A tangible processor-readable storage medium having stored thereon processor-executable software instructions configured to cause a processor to perform steps comprising:
activating a call active animation routine upon initiation of a voice call session; and
deactivating the call active animation routine upon termination of the voice call session.

68. The tangible processor-readable storage medium of claim 67 further having stored thereon processor-executable software instructions configured to cause a processor to further perform steps comprising displaying a sequence of images which exhibits near continuous motion on a user interface output display.

69. The tangible processor-readable storage medium of claim 68 further having stored thereon processor-executable software instructions configured to cause a processor to further perform steps comprising displaying a static image on the user interface output display

70. The tangible processor-readable storage medium of claim 68 further having stored thereon processor-executable software instructions configured to cause a processor to further perform steps comprising recalling the sequence of images from a memory.

71. The tangible processor-readable storage medium of claim 68, further having stored thereon processor-executable software instructions configured to cause a processor to further perform steps comprising modifying a recalled image to generate a plurality of modified images such that motion is perceived when the plurality of modified images are exhibited on the user interface output display in succession.

72. The tangible processor-readable storage medium of claim 70, further having stored thereon processor-executable software instructions configured to cause a processor to further perform steps comprising coordinating the recalled sequence of images with a theme selected by a user.

73. The tangible processor-readable storage medium of claim 70, further having stored thereon processor-executable software instructions configured to cause a processor to further perform steps comprising recalling a portion of a theme selected by the user.

74. The tangible processor-readable storage medium of claim 68, further having stored thereon processor-executable software instructions configured to cause a processor to further perform steps comprising sequentially modifying a portion of a theme implemented on the user interface output display and displaying the modified portion on the user interface output display such that motion is perceived on the portion of the user interface output display in succession.

75. The tangible processor-readable storage medium of claim 69 further having stored thereon processor-executable software instructions configured to cause a processor to further perform steps comprising removing the static image from the user interface output display after a pre-determined period of time has elapsed.

76. The tangible processor-readable storage medium of claim 67 further having stored thereon processor-executable software instructions configured to cause a processor to further perform steps comprising indicating the duration of the terminated voice call session via the static image.

77. The tangible processor-readable storage medium of claim 76 further having stored thereon processor-executable software instructions configured to cause a processor to further perform steps comprising resetting the static image to a base setting after a pre-determined period of time has elapsed.

78. A tangible processor-readable storage medium having stored thereon processor-executable software instructions configured to cause a processor to perform steps comprising:
monitoring a voice call session status;
activating a call active animation routine if a voice call session is active; and
deactivating the call active animation routine if the voice call session is no longer active.

79. The tangible processor-readable storage medium of claim 78 further having stored thereon processor-executable software instructions configured to cause a processor to further perform steps comprising displaying a sequence of images which exhibits near continuous motion on a user interface output display.

80. The tangible processor-readable storage medium of claim 79 further having stored thereon processor-executable software instructions configured to cause a processor to further perform steps comprising displaying a static image on the user interface output display.

81. The tangible processor-readable storage medium of claim 79 further having stored thereon processor-executable software instructions configured to cause a processor to further perform steps comprising recalling the sequence of images from memory.

82. The tangible processor-readable storage medium of claim 79, further having stored thereon processor-executable software instructions configured to cause a processor to further perform steps comprising modifying a recalled image to generate a plurality of modified images such that motion is perceived when the plurality of modified images are exhibited on the user interface output display in succession.

82. The tangible processor-readable storage medium of claim 81, further having stored thereon processor-executable software instructions configured to cause a processor to further perform steps comprising coordinating the recalled sequence of images with a theme selected by a user.

83. The tangible processor-readable storage medium of claim 81, further having stored thereon processor-executable software instructions configured to cause a processor to further perform steps comprising recalling a portion of a theme selected by the user.

84. The tangible processor-readable storage medium of claim 79, further having stored thereon processor-executable software instructions configured to cause a processor to further perform steps comprising sequentially modifying a portion of a theme implemented on the user interface output display and displaying the modified portion on the user interface output display such that motion is perceived on the portion of the user interface output display in succession.

85. The tangible processor-readable storage medium of claim 79 further having stored thereon processor-executable software instructions configured to cause a processor to further perform steps comprising removing the static image from the user interface output display after a pre-determined period of time has elapsed.

86. The tangible processor-readable storage medium of claim 79 further having stored thereon processor-executable software instructions configured to cause a processor to further perform steps comprising indicating the duration of the terminated voice call session via the static image.

87. The tangible processor-readable storage medium of claim 86 further having stored thereon processor-executable software instructions configured to cause a processor to further perform steps comprising resetting the static image to a base setting after a pre-determined period of time has elapsed.
